(19) United States
(12) Patent Application Publication
(10) Pub. No.: US 2003/0176162 A1
(43) Pub. Date: Sep. 18, 2003

(54) Wireless participation in betting or lottery systems

(76) Inventors: Peter Planki, Munich (DE); Karl-Heinz Lettmair, Stoffen (DE)

Correspondence Address: SPENCER, FANE, BRITT & BROWNE, 1000 WALNUT STREET, SUITE 1400, KANSAS CITY, MO, 64106-2140, US

(21) Appl. No.: 10/276,638

(22) PCT Filed: May 16, 2001
(86) PCT No.: PCT/EP01/05591

(30) Foreign Application Priority Data
May 16, 2000 (DE) 100 23 848.3

(51) Int. Cl. G06F 17/60; H04H 1/00

(52) U.S. Cl. 455/3.01; 705/1

(57) ABSTRACT

The invention relates to a communication system or a method for wireless participation in a betting system, e.g. a lottery, football pools, horse-race betting, bingo or another betting or lottery system. The inventive communication system comprises a betting device (2), which receives and verifies the identification information of a player registered in the betting system, whereby said identification information is transmitted via a portable terminal (1) of a wireless telecommunications system and whereby the betting device (2) authorizes the participation of the player in the betting system using the portable terminal (1), dependent on the verification that the participation fee can be paid. The invention enables a player to flexibly participate in a betting or lottery system, independent of location and time.

The present invention relates to a communication system and a method for wireless participation in a betting system, e.g. a lottery, football pools, bingo or another betting or lottery system. The present invention is particularly designed to authorize a player to participate in such a betting system by means of a portable terminal, as for example a wireless phone of a telecommunication system, as for example of the GSM- or the UMTS-system.

The prior art discloses several systems and/or methods of participation in betting systems, such as e.g. lottery, football pools, horse-racing betting, bingo or other betting or lottery systems. Normally, the player has to visit a respective agency in order to participate in a lottery system, has to fill in a form and has to pay a respective participation fee at once. This bears the disadvantage that the player has to visit a respective agency and moreover is bound to observe the opening hours of this place. This is a particular disadvantage, when the player is at a place where he does not know the next respective agency. Therefore, the present betting systems are not flexible and depend on place and time.

It is therefore the object of the present invention to provide a communication system and a method for participating in a betting r lottery system allowing a player a flexible participation independent of time and place, in a betting or lottery system. At the same time, the operator of the betting system should be guaranteed the highest possible degree of solvency with respect to the participation fee of the participant.

This object is solved by the communication system and a method for a wireless participation in a betting or lottery system according to claims 1 and 5. The inventive communication system comprises a betting means receiving an identification information of a player registered in said betting system, whereby the identification information is transmitted via a portable terminal of a wireless telecommunication system, and whereby the betting means authorizes participation of the player in the betting system via said portable terminal in response to the verification that the participation fee can be paid. According to the inventive method of a wireless participation in a betting system, an identification information of a player registered in the betting system is transmitted via a portable terminal of a wireless telecommunication system and supplied to a betting means, a solvency control with respect to the participation fee is effected and participation of the player in the betting system is authorized in response to said control via said portable terminal.

Due to the use of a portable terminal, e.g. a wireless phone of the GSM- or UMTS-system, the present invention allows a player a flexible participation independent of place and time (all day long, 24 hours a day, day and night) in a betting or lottery system, as for example a lottery, football pools, horse-race betting or other betting and lottery systems. The solvency control of the registered player guarantees that the operator of the betting system receives the player's participation fee. The player may contact the betting means via his portable terminal at any time to place his bet, even shortly before the winning Lotto numbers are drawn, before the start of a race or the like. Furthermore, in case of a winning, the player may be contacted at any time via his portable terminal so that the risk that the winning becomes invalid is minimized. It is, however, necessary for the player to be registered in the betting means, i.e. that personal data of the player are known to the betting means.

In an advantageous case, the betting means receives the identification information directly from the portable terminal and the solvency control is a control of contracted payment arrangements of the player with a respective bank. The registered player may, for example, have deposited a debit order or his credit card information in the betting means, so that the betting means may automatically deduct the participation fee when the player places a bet. A “bank” in this sense may also be a Trust-or a Clearing-Centre.

In addition or as an alternative the betting means may receive the identification information directly from the portable terminal, which is operated via a prepaid card, whereby solvency control is effected in relation to the respective network operator. Due to the prepaid card the player has a credit at the respective network operator, which he may use for paying participation in his bet. The “network operator” hence is not only the enterprise providing technical devices for the telephone and new transfer, but also the player's contracting mobile phone company, to which he pays his telephone fees or where he bought his telephone card.

As a further alternative, the betting means may receive the identification information via a bank, to which the identification information is transmitted directly via the portable terminal, whereby solvency control is effected by said bank

The present invention is explained in greater detail hereinbelow by preferred embodiments with respect to the attached figures, wherein

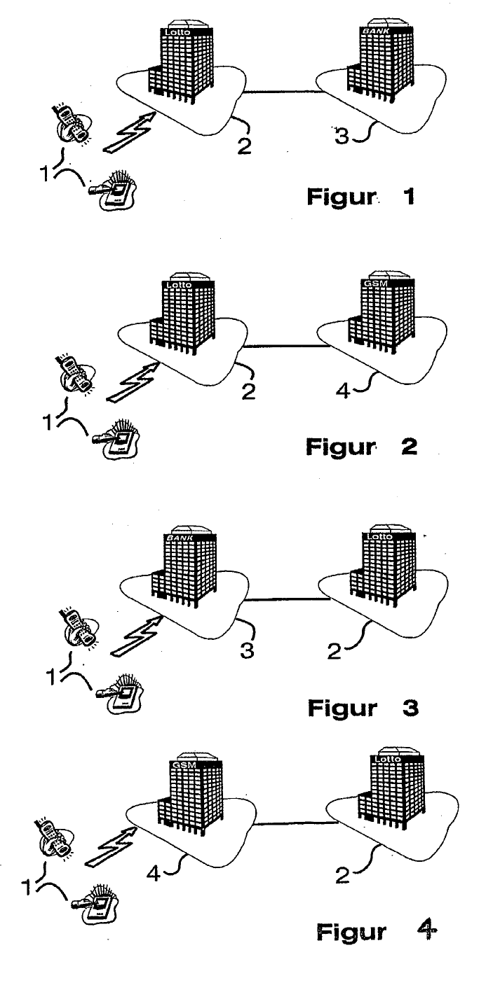

FIG. 1 shows a first embodiment of the inventive communication system,

FIG. 2 shows a second embodiment f the inventive communication system, and

FIG. 3 shows a third embodiment of the inventive communication system.

FIG. 4 shows a fourth embodiment of the inventive communication system.

FIG. 1 shows a first embodiment of the inventive communication system having a portable terminal 1 of a wireless telecommunication system, a betting means 2, e.g. for a lottery, football pools, horse-race betting, bingo systems or other betting and lottery systems, and a bank 3. The betting means 2 and the bank 3 are, for example, connected via a ground network telephone line. The portable terminal 1 may for example be a wireless phone, e.g. a mobile phone, or another device suited for communication in the wireless telecommunication system, as for example a laptop, a computer, a personal digital assistant or the like. The wireless telecommunication system may for example be the GSM-system, the UMTS-system or any other suitable telecommunication system. The transmission of data between the portable terminal 1 and the betting device 2 is effected in a suitable data transmission channel, as for example the widely used SMS-system (short message service) or developments thereof, i.e. the EMS (Enhanced Message Service) and the MMS (Multimedia Message Service).

These communication networks are for example described in Simon Buckingham: “Next Messaging: From MS to EMS to MMS”, Mobile Lifestreams Ltd., 2000.

The player is registered in the betting means 2, i.e. known by name and residence. If the player wants to participate in a bet, he contacts the betting means 2 for example via a special telephone number or sends a respective data message or text to the special telephone number of the betting means 2. The betting means 2 responds and asks for the identification information by means of which the registered player identifies with respect to the betting means 2. As an alternative, it is also possible to transmit the identification information during the first call, either by the player himself or from the memory of the mobile phone. This identification information may for example be a code number or a betting pin allocated to the player when registering. The player feeds this code number or betting pin into his portable terminal 1 and transmits it to the betting means 2. The latter receives the identification information and checks it, i.e. compares it to the registered data of the inquiring player.

Furthermore, the betting means 2 has to guarantee that the participation fee, due when placing the bet, is paid by the player. For this purpose, the player must have deposited a debit order from his account at the bank 3 or his credit card information for debiting his participation fee from a credit card account, when registering with the betting means 2. When receiving the player's inquiry by means of the transmitted identification information, the betting means 2 controls if solvency is guaranteed, for example by inquiring at the bank, if the account is covered, and then transmits the authorization for participation in the betting system to the player's portable terminal 1. This authorization may, for example, be effected via transmission of software for the betting surface or game application, respectively. If the betting surface or game application is already present in the portable terminal 1, the authorization may, for example, be effected by transmission of a respective code, clearing the betting surface or game application and makes it accessible to the player. Then, the display of the portable terminal for example shows a Lotto coupon, which may be filled in accordingly by the player. After a respective choice of the bet and a determination concerning the betting stake, the data are transferred from the portable terminal 1 to the betting means 2. Then, the betting means 2 may, for example, return a confirmation to the portable terminal and ask the player to confirm the bet and to mention the participation fee. As an alternative, this participation fee may be indicated to the player already upon having fed the bet to the betting surface. Then, the betting means 2 automatically debits the participation fee from the player's account at the bank 3 or from the credit card account and confirms the placed bet to the player by means of a respective confirmation to the portable terminal 1.

In case of a winning, the sum is automatically credited to the player's account or he is again informed via his portable terminal 1, in order to personally collect his winning.

The advantage of the embodiment of the inventive communication system shown in FIG. 1 is the direct connection between the portable terminal 1 and the betting means 2, as the registered player may operate his portable terminal 1 with a so-called prepaid card, i.e. with a prepaid card of the network operator, as well as with a card of the network operator connected with a fixed card contract. In case of the fixed card contract, the respective network operator knows who is the owner of the portable terminal 1, whereas this is not the case for prepaid cards. In the latter case, the network operator merely has the relation between the pin (personal identification number) and the prepaid and credited amount of money on the internal account.

The embodiment of the inventive communication system shown in FIG. 2 differs from the first embodiment shown in FIG. 1 by a special suitability for the use with prepaid cards for the portable terminal 1. In this case the betting means 2 is connected with the network operator 4 and controls the solvency when receiving the inquiry of a registered player by contacting the network operator 4. If the player, due to his prepaid card for the portable terminal 1, disposes of a sufficient amount of money on his internal account at the network operator 4, the betting means 2 authorizes the player to participate in the respective bet. The remaining routine of placing and releasing a bet corresponds to the routine described in connection with the first embodiment, so that a repetition does not seem necessary. The network operator 4 does not know the player's identity, but only knows the allocation of the pin code of the prepaid card of the player and of the prepaid amount of money on the internal account. When receiving a player's inquiry, the betting means 2 has to ask for the pin code of the prepaid card and transfer this information to the network operator 4. If the prepaid amount of money is sufficient, the betting means 2 authorizes the player to participate in the desired bet.

The third embodiment of the inventive communication system shown in FIG. 3 differs from the first and second embodiments by the direct contact between the portable terminal 1 of the registered player and a bank 3 or a similar institution. The bank, again, is connected with the betting means 2 and forwards a respective betting inquiry of a player registered in the betting means 2. The betting system may, for example, be provided as sub-menu of the Online-bank-menu on the portable terminal 1. Through the portable terminal 1 the player contacts his bank 3 via the Online-bank-menu by submitting the bank pin code allocated to him by the bank. After successful control of the bank pin code, the bank transmits a confirmation to the player, whereupon the player may select the sub-menu betting system on his portable terminal 1 and transmit his betting pin code, allocated by said betting means 2 when registering, to the bank 3. The bank forwards this pin code, which basically contains an inquiry to participate in the betting system, to the betting means 2. At the same time, the solvency is checked by the bank 3 with respect to the participation fee on the player's behalf, and a corresponding information is forwarded to the betting means 2. In case of a positive check, the betting means authorizes the participant to participate in the bet and the player receives a respective confirmation. This confirmation may be, as already explained with respect to the first embodiment, the activation of the betting surface or game application already contained in the portable terminal 1, or the transfer of the betting surface. Then, the player chooses his bet on the betting surface and submits respective data via the bank 3 to the betting means 2. The participation fee is correspondingly debited from the player's account at the bank 3. An eventual winning is automatically credited to the player's account. It has to be indicated, that the third embodiment of the inventive communication system cannot be operated with prepaid cards in the portable terminal 1, as the bank 3 normally only puts the Online bank software at the disposal of users with known identity.

Similar to the second embodiment, the fourth embodiment according to FIG. 4 presupposes that the cashless payment may also be effected via a prepaid card or the player's account at the network operator 4 or via the contracting telephone company of the mobile phone. In the following, the latter is also called “network operator” and in FIG. 4 “GSM”. First, the player contacts the network operator who examines the status of the prepaid card or the account. In case of a successful examination, the further routine corresponds to the embodiment of FIG. 3, i.e. the network operator transfers a solvency information to the betting means 2 and a confirmation to the player, who then places is bet and transfers these data to the betting means via the network operator.

When using the portable terminal 1 in the GSM- or UMTS-system, all four embodiments of the inventive communication system dispose of an additional protection concerning the wireless transfer of data due to the automated encoding of the data transfer:

1. Communication system for a wireless participation in a betting or lottery system, comprising: a betting means (2) receiving and controlling an identification information of a player registered in a betting or lottery system, whereby said identification information is transmitted via a portable terminal (1) of a wireless telecommunication system and whereby said betting means (2), in response to the solvency with respect to the participation fee authorizes participation of the player in the betting system by means of said portable terminal (1).

2. Communication system according to claim 1, characterized in tat said betting means (2) receives the identification information directly from the portable terminal (1) and that the solvency control is a control of fixed payment arrangements of the registered player with respect to a bank.

3. Communication system according to claim 1, characterized in that,
said betting means receives the identification information directly from said portable terminal (1) which is operated by a prepaid card and the solvency control is effected in connection with the respective network operator (4).

4. Communication system according to claim 1, characterized in that
said betting means (2) receives the identification information via a bank (3) to which the identification information has been transmitted directly from said portable terminal (1), and that a control of the payment arrangements is effected by the bank (3). identification

5. Communication system according to claim 1, characterized in that
said betting means (2) receives the identification information directly through the player's network operator (4) to whom the identification information was transmitted directly from the portable terminal (1), and that the control of the payment arrangements is effected by the network operator (4).

6. Communication system according to one of claims 1 to 4, characterized in that
the data transfer channels for the information transfer between said portable terminal (1) and said betting means (2), and/or between said betting means 82) and said bank (3) and/or between said bank (3) and said portable terminal (1) operate in accordance with one of the standards of SMS, EMS and/or MMS.

7. A method for the wireless participation in a betting system, wherein the identification information of a player, registered in the betting system, is transmitted via a portable terminal (1) of a wireless telecommunication system and is supplied to a betting means (2),
wherein a solvency control is effected with respect to the participation fee, and
the player's participation in the betting system is authorized by means of said portable terminal (1) in response to the solvency control.

8. Method according to claim 7, characterized in that
said identification information of said betting means (2) is directly transferred by said portable terminal (1) and that the solvency control is a control of determined payment arrangements referring to a bank (3) of said registered player.

9. Method according to claim 7, characterized in that
said identification information of said betting means (2) is transferred directly from said portable terminal (1), operated by a prepaid card, and that solvency control is effected in connection with the respective network operator (4).

10. Method according to claim 7, characterized in that
said identification information is directly transferred to a bank (3) via said portable terminal (1), said bank transferring said information to the betting means (2), whereby solvency control is effected in said bank (3).

11. Method according to claim 7, characterized in that
said identification information is transferred from said portable terminal (1) to said network operator (4), who transfers it to said betting means (2), whereby solvency control is effected by said network operator (4).

12. Method according to any of claims 7 to 11, characterized in that
the transfer of information between said portable terminal (1) and said betting means, and/or between said betting means (2) and said bank (3) and/or between said bank (3) and said portable terminal (1) is effected in accordance with one of the following standards: SMS, EMS and/or MMS.
